(19) United States
(12) Patent Application Publication
(10) Pub. No.: US 2002/0101047 A1
(43) Pub. Date: Aug. 1, 2002

(54) Tanapole

(76) Inventor: Sonya Noel Drury Chesser, Lawrencebury, KY (US)

Correspondence Address: Sonya N. Chesser, 1457 Kays Road, Lawrenceburg, KY, 40342, US

(21) Appl. No.: 10/041,878

(22) Filed: Mar. 29, 2002

Related U.S. Application Data
(60) Provisional application No. 60/262,790, filed on Jan. 22, 2001.

(51) Int. Cl. B62B 3/00

(52) U.S. Cl. 280/47.35; 280/79.3

(57) ABSTRACT

A shopping cart construction that includes a cylinder shaped aluminum cart mounted on a set of wheels which has a low profile sufficient to easily pass between clothing racks and which includes a vertical support pole extending upward from the center thereof having a number of hanging racks supported at the top of the center pole and middle hooks extending from the center side of the center pole.

### TECHNICAL FIELD

The present invention relates to shopping carts and more particularly to a shopping cart construction that includes an upright cylinder shaped aluminum cart having a center support pole extending upwardly therefrom and rollably mounted on a set of wheels, two upper hanging racks supported at the top of the center pole and middle hooks extending from the center side of the center support pole.

### BACKGROUND OF INVENTION

It is often difficult to shop for a number of items without the benefit of a shopping cart. Shopping carts are typically difficult to maneuver around, especially in clothing stores, because racks of clothing can prevent the cart from easily passing between the racks. It would be a benefit, therefore, to have a shopping cart construction that included a cylinder shaped aluminum cart mounted on a set of wheels which was low enough to pass easily between clothing racks and which included a vertical support pole from which clothing items could be easily hung as they are selected.

### SUMMARY OF INVENTION

It is thus an object of the invention to provide a shopping cart construction that includes an upright cylinder shaped aluminum cart having a center support pole extending upwardly therefrom and rollably mounted on a set of wheels, two upper hanging racks supported at the top of the center pole and middle hooks extending from the center side of the center support pole.

Accordingly, a shopping cart construction is provided. The shopping cart construction includes an upright cylinder shaped aluminum cart having a center support pole extending upwardly therefrom and rollably mounted on a set of wheels, two upper hanging racks supported at the top of the center pole and middle hooks extending from the center side of the center support pole.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 shows a perspective view of an exemplary embodiment of the shopping cart construction of the present invention.

### EXEMPLARY EMBODIMENTS

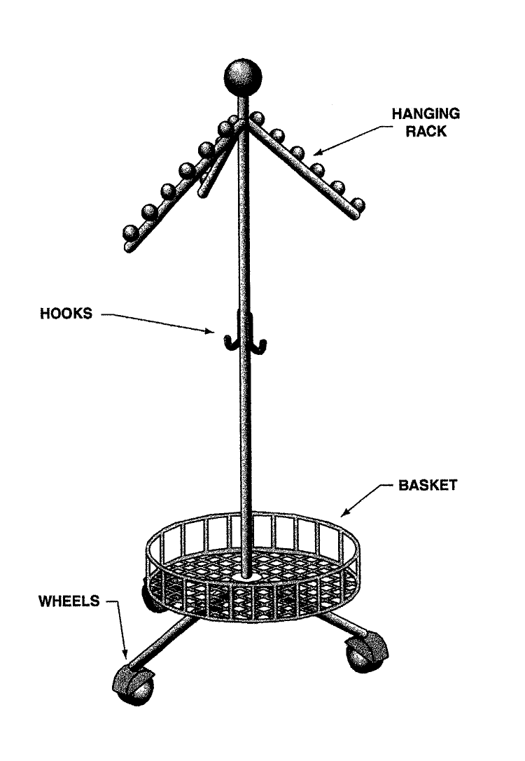

FIG. 1 shows an exemplary embodiment of the shopping cart construction of the present invention generally designated 10. Shopping cart construction 10 includes an upright cylinder shaped cart 12 having a center support pole 14 extending upwardly from a center 16 thereof that terminates at a top end 18 in three hanging racks 20 and which has a pair of hooks 22 extending from the center 24 thereof. Upright cylinder shaped cart 12 has a number of wheels 26 connected to the bottom thereof for rollably supporting shopping cart construction 10.

It can be seen from the preceding description that a shopping cart construction has been provided.

It is noted that the embodiment of the shopping cart construction described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

I claim:

1. A mobile cart for carrying clothes on hangers comprising:
a base including a platform for supporting objects;
a plurality of leg members projecting outwardly from said base;
a plurality of wheels, with at least one wheel mounted to a respective leg member;
an upstanding pole member projecting upwardly from said base; and
at least one rack member projecting outwardly from said pole, said rack member being configured for supporting at least one clothing item disposed on a hanger.

2. A mobile cart according to claim 1 and further comprising at least one support member projecting upwardly from said platform to form a storage compartment on said base.

3. A mobile cart according to claim 2 wherein said platform and said at least one support member form a basket structure.

4. A mobile cart according to claim 2 wherein said platform is generally round, and said basket is generally cylindrical.

5. A mobile cart according to claim 1 and further comprising at least one hook mounted to said pole.

6. A mobile cart according to claim 1 wherein said pole projects from a general center of said base.

7. A mobile cart according to claim 1 and further comprising at least one stop member formed on said at least one rack member.

8. A mobile cart according to claim 1 wherein said wheels are formed as casters.

9. A mobile cart according to claim 1 and further comprising a gripping member disposed at a distal end of said pole for maneuvering and guiding said cart.

10. A mobile cart for carrying clothes on hangers comprising:
a base including a platform for supporting objects and at least one support member projecting upwardly from said platform to form a storage compartment on said base, wherein said platform and said at least one support member form a basket structure;
a plurality of leg members projecting outwardly from said base;
a plurality of wheels, with at least one wheel mounted to a respective leg member;
an upstanding pole member projecting upwardly from said base;
a plurality of rack members projecting outwardly from said pole, said rack members being configured for supporting at least one clothing item disposed on a hanger; and
at least one stop member formed on each said rack member.

11. A mobile cart according to claim 10 wherein said platform is generally round, and said basket is generally cylindrical.

12. A mobile cart according to claim 10 and further comprising at least one hook mounted to said pole.

13. A mobile cart according to claim 10 wherein said wheels are formed as casters.

14. A mobile cart according to claim 11 and further comprising a gripping member disposed at a distal end of said pole for maneuvering and guiding said cart.

15. A mobile cart according to claim 10 wherein said pole projects from a general center of said base.

16. A mobile cart for carrying clothes on hangers comprising:
a base including a generally circular platform for supporting objects and at least one support member projecting upwardly from said platform to form a storage compartment on said base, wherein said platform and said at least one support member form a basket structure;
three leg members projecting outwardly from said base at a substantially equidistant spacing thereabout;
three wheels, with one wheel mounted to a respective leg member, said wheels being configured for full rotation about a vertical axis, in addition to rotation about a horizontal axis;
an upstanding pole member projecting upwardly from a general center of said base;
three rack members projecting outwardly from said pole, said rack members being disposed at a downward angle from a horizontal plane and configured for supporting clothing items disposed on hangers; and
a plurality of stop members formed on each said rack member for hanger abutment thereagainst.
